(19) United States
(12) Patent Application Publication
(10) Pub. No.: US 2017/0359621 A1
(43) Pub. Date: Dec. 14, 2017

(54) STANDBY MODE CONTROL APPARATUS AND METHOD BASED ON CONTEXT INFORMATION AND USAGE PATTERN ANALYSIS FOR SAVING POWER CONSUMPTION OF TERMINAL

(71) Applicant: Electronics and Telecommunications Research Institute, Daejeon (KR)

(72) Inventors: Hyun Ho PARK, Daejeon (KR); Eun Jung KWON, Daejeon (KR); Jung Hak KIM, Daejeon (KR); Sung Won BYON, Seongnam-si (KR); Yong Tae LEE, Daejeon (KR); Eui Suk JUNG, Daejeon (KR); Hyun Woo LEE, Seoul (KR)

(73) Assignee: Electronics and Telecommunications Research Institute, Daejeon (KR)

(21) Appl. No.: 15/443,858

(22) Filed: Feb. 27, 2017

(30) Foreign Application Priority Data
Jun. 13, 2016 (KR) 10-2016-0073315

(51) Int. Cl. H04N 21/443; H04N 21/442; H04L 12/12; H04L 29/08

(52) U.S. Cl. CPC H04N 21/4436; H04L 12/12; H04N 21/44222; H04N 21/44204; H04N 21/4424; H04L 67/12

(57) ABSTRACT

The present invention relates to a standby mode control apparatus and method for saving power consumption of a wired/wireless terminal, such as a set-top box or an Internet of Things (IoT) device, by controlling the terminal on the basis of a terminal usage pattern and context information of the terminal, wherein the standby mode control apparatus may include an activation history information generator and a standby mode determiner, and according to the present invention, since a standby mode is controlled and set by predicting a terminal usage pattern of a user, it provides user convenience and saves power consumption during a standby period, and it provides more effectively save power consumption during the standby period through more accurate prediction using a usage probability calculated by analyzing context information.

### CROSS-REFERENCE TO RELATED APPLICATION

This application claims priority to and the benefit of Korean Patent Application No. 10-2016-0073315, filed on Jun. 13, 2016, the disclosure of which is incorporated herein by reference in its entirety.

### BACKGROUND

### 1. Field of the Invention

The present invention relates to a standby mode control apparatus and method which control a wired/wireless terminal, such as a set-top box or an Internet of Things (IoT) device, on the basis of a usage pattern and context information of the terminal for saving power consumption of the terminal.

### 2. Discussion of Related Art

There is an increasing interest in power reduction, and accordingly reducing standby power consumed by a terminal set to standby mode is required. In particular, an average standby power of general imaging devices is 1 W, while a set-top box consumes 12.27 W, which is ten-times or more than the average power consumption of imaging devices. More than 20 million set-top boxes are operated in South Korea, and thus reducing standby power of a set-top box has become an important issue in terms of national power management.

Therefore, in order to reduce standby power of set-top boxes, studies on a method of managing power of a set-top box on the basis of network cooperation in which a passive standby mode, an active standby mode, and an active mode of the set-top box is controlled in terms of a network.

### SUMMARY OF THE INVENTION

In order to address the above-described problems, the present invention proposes a standby mode control apparatus and method for saving power consumption of a terminal by determining context information and a usage history for each time period to predict a usage pattern of the terminal so as to control an operating mode of the terminal.

In one general aspect, there is provided a standby mode control apparatus including a communication module, a memory, and a processor, and configured to save power consumption of a terminal which is operated by the processor configured to execute a program stored in the memory, wherein the processor includes an activation history information generator configured to collect a terminal activation history during a predetermined period of time and accumulate the collected activation history for each time period to generate cumulative activation history information, and a standby mode determiner configured to compare a cumulative activation history of each time period contained in the generated cumulative activation history information with a preset threshold value, set a terminal to an active standby mode in a corresponding time period when a period of activation time is greater than the threshold value, and set the terminal to a passive standby mode in a corresponding time period when the period of activation time is smaller than the threshold value.

The processor may further include a threshold value setter configured to reset the preset threshold value using a standby power consumption value and a prediction success rate in each preset period of time.

The threshold value setter may increase the threshold value when the standby power consumption value, which is a total sum of power consumed by the terminal in a standby mode during a specific period of time, is greater than a reference standby power consumption value.

The threshold value setter may decrease the threshold value when the prediction success rate, which is a rate of the terminal being activated from the active standby mode when the terminal is switched from a standby mode to an active mode, is lower than a reference success rate.

The processor may further include a usage probability applier configured to calculate a usage probability of a user using the terminal, set the terminal to the active standby mode when the usage probability is higher than a reference usage probability, and set the terminal to the passive standby mode when the usage probability is lower than the reference usage probability.

The usage probability applier may calculate the usage probability of the user using the terminal using day, month, season, and weather information for each time period.

The usage probability applier may calculate the usage probability of the user using the terminal using characteristic information of a region or a place.

The usage probability applier may calculate the usage probability of the user using the terminal using user personal information generated by analyzing the terminal activation history.

In another general aspect, there is provided a standby mode control method for saving power consumption of a terminal, including: collecting a terminal activation history during a predetermined period of time and generating cumulative activation history information by accumulating the collected activation history for each time period; and comparing a cumulative activation history of each time period contained in the generated cumulative activation history information with a preset threshold value, setting a terminal to an active standby mode in a corresponding time period when a period of activation time is greater than the threshold value, and setting the terminal to a passive standby mode in a corresponding time period when the period of activation time is smaller than the threshold value.

The standby mode control method may further include resetting the preset threshold value using a standby power consumption value and a prediction success rate in each preset period of time.

The resetting of the threshold value may include increasing the threshold value when the standby power consumption value, which is a total sum of power consumed by the terminal in a standby mode during a specific period of time, is greater than a reference standby power consumption value.

The resetting of the threshold value may include decreasing the threshold value when the prediction success rate, which is a rate of the terminal being activated from the active standby mode when the terminal is switched from a standby mode to the active mode, is lower than a reference success rate.

The standby mode control method may further include calculating a usage probability of a user using the terminal, setting the terminal to the active standby mode when the usage probability is higher than a reference usage probability, and setting the terminal to the passive standby mode when the usage probability is lower than the reference usage probability.

The setting of the terminal to the passive standby mode may include calculating the usage probability of the user using the terminal using day, month, season, and weather information for each time period.

The setting of the terminal to the passive standby mode may include calculating the usage probability of the user using the terminal using characteristic information of a region or a place.

The setting of the terminal to the passive standby mode may include calculating the usage probability of the user using the terminal using user personal information generated by analyzing the terminal activation history.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram of a standby mode control apparatus for saving power consumption of a terminal according to a first embodiment of the present invention;

FIG. 2 is a configuration diagram of a standby mode control apparatus for saving power consumption of a terminal according to a second embodiment of the present invention;

FIG. 3 is a configuration diagram of a standby mode control apparatus for saving power consumption of a terminal according to a third embodiment of the present invention;

FIG. 4 is a diagram illustrating cumulative activation history information generated by accumulating a collected activation history for each time period according to one embodiment of the present invention;

FIG. 5 is a diagram illustrating determination of a standby mode by comparing a cumulative activation history of each time period with a preset threshold value according to one embodiment of the present invention;

FIG. 6 is a flowchart illustrating a method of resetting a preset threshold value using a standby power consumption value according to one embodiment of the present invention;

FIG. 7 is a flowchart illustrating a method of resetting a preset threshold value using a prediction success rate according to one embodiment of the present invention;

FIG. 8 is a diagram illustrating a calculation of a usage probability of a user using a terminal by using day, month, season, and weather information for each time period;

FIG. 9 is a diagram illustrating a calculation of a usage probability of a user using a terminal by using characteristic information of a region or a place;

FIG. 10 is a diagram illustrating a calculation of a usage probability of a user using a terminal by using user personal information generated by analyzing a terminal activation history according to one embodiment of the present invention; and

FIG. 11 is a flowchart illustrating a standby control method for saving power consumption of a terminal.

### DETAILED DESCRIPTION OF EXEMPLARY EMBODIMENTS

The present invention will be described more fully hereinafter with reference to the accompanying drawings, in which exemplary embodiments of the invention are shown. However, the present invention may be embodied in many different forms and is not to be construed as being limited to the embodiments set forth herein.

Also, irrelevant details have been omitted from the drawings for increased clarity and conciseness, and similar parts are indicated by similar reference numerals throughout the detailed description.

Throughout the detailed description, the term “comprise” and its variations, such as “comprises” or “comprising,” should be understood as implying the inclusion of stated elements and not as excluding any other elements unless explicitly described to the contrary.

Hereinafter, a standby mode control apparatus and method for saving power consumption of a terminal will be described.

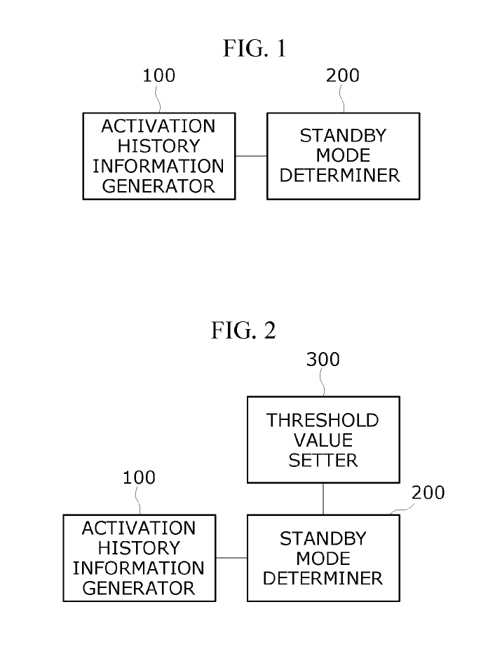

FIG. 1 is a configuration diagram of a standby mode control apparatus for saving power consumption of a terminal according to a first embodiment of the present invention.

Referring to FIG. 1, the standby mode control apparatus for saving power consumption of a terminal includes an activation history information generator 100 and a standby mode determiner 200.

The activation history information generator 100 may collect a terminal activation history during a predetermined period of time and accumulate the collected activation history for each time period to generate cumulative activation history information.

Here, the predetermined period of time refers to a period arbitrarily set by a user, and may be set by the user in units of days, weeks, months, years, etc. without limitation.

The generated cumulative activation history information will be described in detail with reference to FIG. 4.

The standby mode determiner 200 may compare a cumulative activation history of each time period contained in the generated cumulative activation history information with a preset threshold value, and set a terminal to an active standby mode in a corresponding time period when a cumulative activation history value is greater than the threshold value, or set the terminal to a passive standby mode in a corresponding time period when the cumulative activation history value is smaller than the threshold value.

In this case, the active standby mode may refer to an operating mode in which most functions of the terminal are activated and stand by in an operation-favored state.

In contrast, the passive standby mode may refer to an operating mode in which most of the functions of the terminal are deactivated and stand by in a power saving-favored state.

According to one embodiment of the present invention, the threshold value may be set by the user, and according to another embodiment, a preset threshold value may be updated periodically.

FIG. 2 is a configuration diagram of a standby mode control apparatus for saving power consumption of a terminal according to a second embodiment of the present invention.

Referring to FIG. 2, the standby mode control apparatus for saving power consumption of a terminal according to the second embodiment further includes a threshold value setter 300 in addition to the configuration of the standby mode control apparatus of the first embodiment.

The threshold value setter 300 may reset a preset threshold value using a standby power consumption value and a prediction success rate in each preset period of time.

According to one embodiment of the present invention, when the standby power consumption value, which is the total sum of power consumed by a terminal in a standby mode during a specific period of time, is greater than a reference standby power consumption value, the threshold value may be increased.

In this case, the standby power consumption value may refer to the total sum of power consumption occurring due to a corresponding terminal standing by in the active standby mode or in the passive standby mode for a specified period of time.

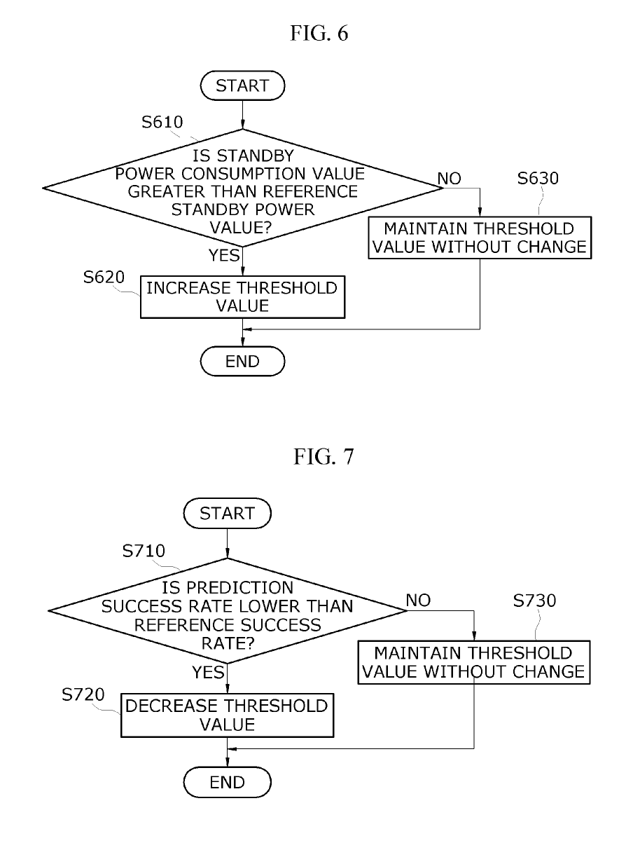

The reset of the preset threshold value using the standby power consumption value will be described in more detail with reference to FIG. 6.

According to one embodiment of the present invention, the threshold value may be decreased when the prediction success rate, which is a rate of a terminal being activated from the active standby mode when the terminal is switched from the standby mode to an active mode, is lower than a reference success rate.

In this case, the prediction success rate may refer to a ratio of the number of transitions from the active standby mode to an active state to the total number of transitions from a standby mode to the active state.

The reset of the preset threshold value using the prediction success rate will be described in more detail with reference to FIG. 7.

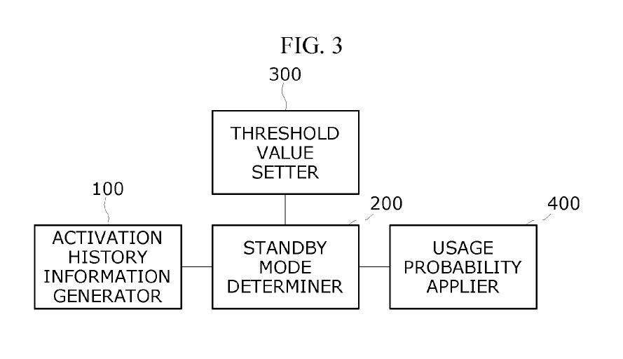

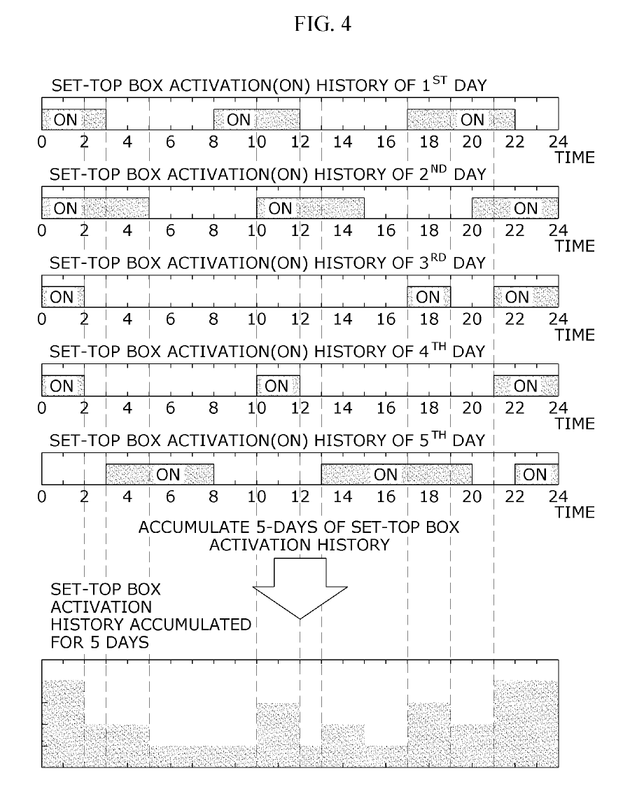

FIG. 3 is a configuration diagram of a standby mode control apparatus for saving power consumption of a terminal according to a third embodiment of the present invention.

Referring to FIG. 3, the standby mode control apparatus for saving power consumption of a terminal according to the third embodiment of the present invention further includes a usage probability applier 400 in addition to the standby mode control apparatus of the first embodiment or the second embodiment.

According to one embodiment of the present invention, the third embodiment may be utilized in combination with the first embodiment or the second embodiment.

According to one embodiment of the present invention, the usage probability applier 400 may calculate a usage probability of a user using a terminal, set the terminal to the active standby mode when the usage probability is higher than a reference usage probability, and set the terminal to the passive standby mode when the usage probability is lower than the reference usage probability.

More specifically, when the third embodiment is utilized in combination with another embodiment (the first embodiment or the second embodiment), a standby mode may be determined by applying a prioritization order of the third embodiment and the other embodiment.

For example, when the third embodiment is combined with the second embodiment, is given a higher priority than the second embodiment, and the second embodiment determines that a terminal should operate in the active standby mode during a time between 10:00 to 12:00 and the third embodiment determines that the terminal should operate in the passive standby mode during the same time period, the terminal may operate in the passive standby mode during a period of 10:00 to 12:00 time according to the third embodiment.

In addition, when the first embodiment is combined with the third embodiment, a probability of selecting the first embodiment is set to 20% and a probability of selecting the third embodiment is set to 80%, and a standby mode may be determined according to the third embodiment with a probability of 0.8.

According to one embodiment of the present invention, the usage probability of the user using the terminal may be calculated using day, month, season, and weather information for each time period.

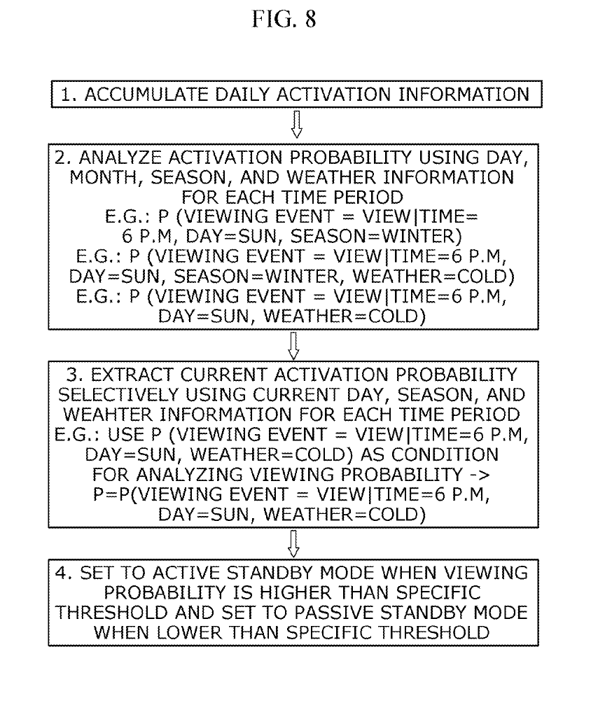

The above will be described in more detail with reference to FIG. 8.

According to one embodiment, the usage probability of the user using the terminal may be calculated using characteristic information of a region or a place.

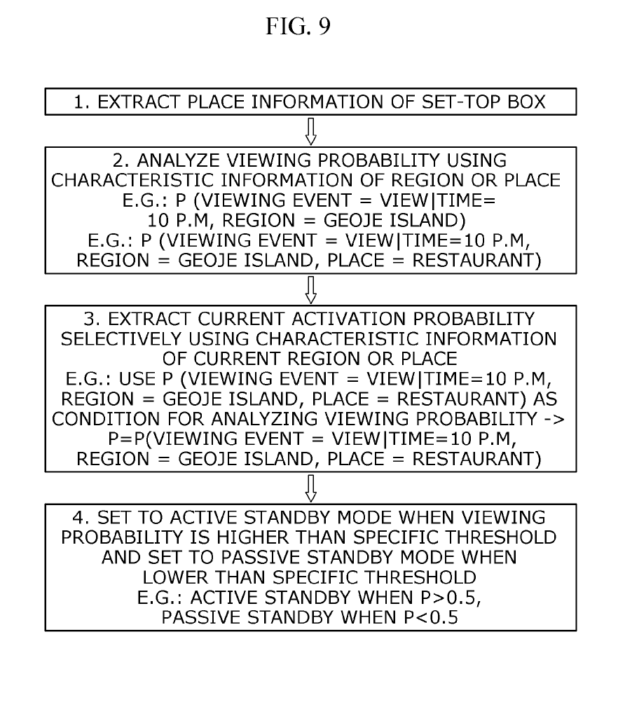

The above will be described in more detail with reference to FIG. 9.

According to one embodiment of the present invention, the usage probability of the user using the terminal may be calculated using user personal information generated by analyzing a terminal activation history.

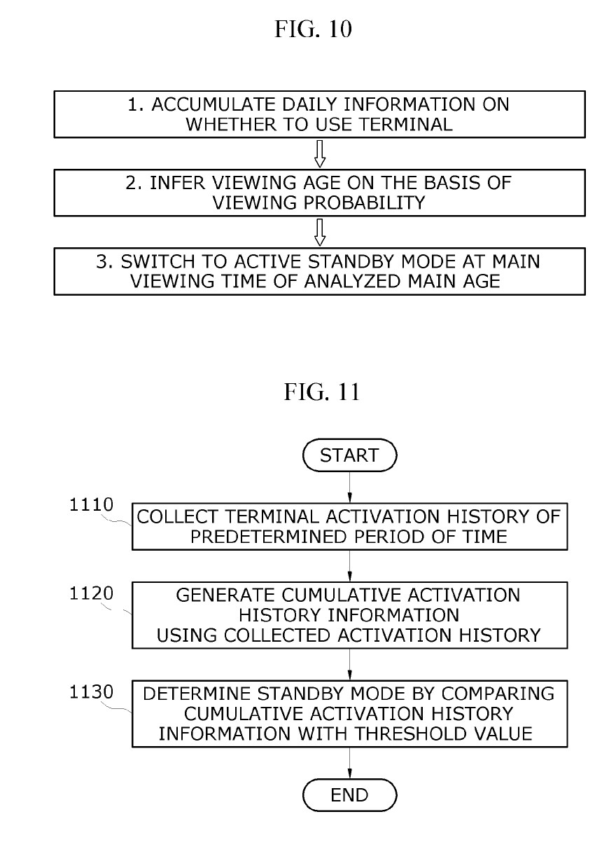

The above will be described in more detail with reference to FIG. 10.

FIG. 4 is a diagram illustrating cumulative activation history information generated by accumulating a collected activation history for each time period according to one embodiment of the present invention.

Referring to FIG. 4, five days of activation history for a specific terminal are shown, and a single piece of cumulative activation history information generated by accumulating the activation history is shown.

According to one embodiment according to the present invention, the cumulative activation history information may be generated by accumulating a activation history for each time period in units of 2 hours, but is not limited thereto. A cumulative activation history may be accumulated for each time period in units of seconds, minutes, hours, days, etc.

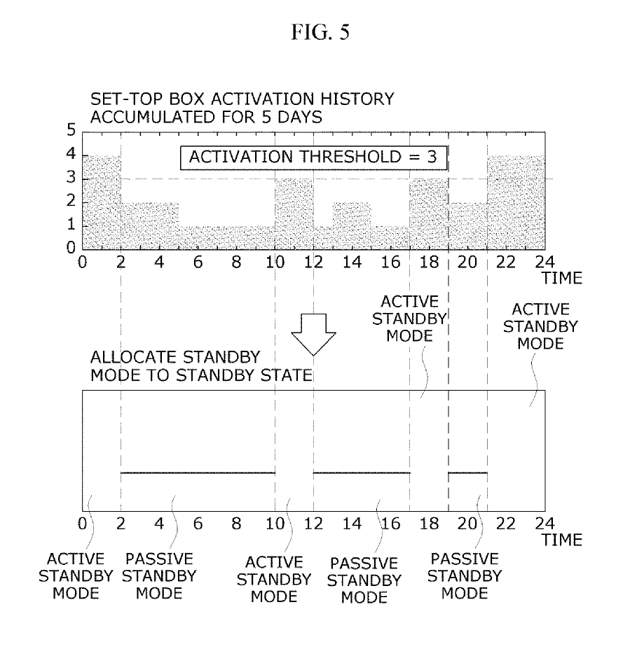

FIG. 5 is a diagram illustrating determination of a standby mode by comparing a cumulative activation history of each time period with a preset threshold value according to one embodiment of the present invention.

Referring to FIG. 5, the cumulative activation history of each time period contained in the cumulative activation history information generated according to one embodiment of the present invention is compared with a preset threshold value, and when a period of activation time is greater than three hours, which is the threshold, the terminal is set to the active standby mode during the time period, and when the period of activation time is less than three hours, the terminal is set to the passive standby mode.

FIG. 6 is a flowchart illustrating a method of resetting a preset threshold value using a standby power consumption value according to one embodiment of the present invention.

Referring to FIG. 6, the method of resetting a preset threshold value by which a standby mode is determined using a standby power consumption value in each predetermined time period is shown.

According to one embodiment of the present invention, a standby mode is set according to a standby mode for each time period that is determined according to a preset threshold value, and when a terminal is currently in a standby state according to the set standby mode, a total amount of power consumed in the standby state during a corresponding time period may be measured as a standby power consumption value.

According to one embodiment of the present invention, the standby power consumption value may be compared with a reference standby power value (610).

In this case, the reference standby power value may be set to a standby power value that is considered appropriate by a user.

According to one embodiment of the present invention, when the standby power consumption value is compared with the reference standby power value and the standby power consumption value is greater than the reference standby power value, the threshold value may be increased (620).

When the threshold value is increased, a duration of time spent in the active standby mode, in which relatively more power is consumed, is reduced while a duration of time spent in the passive standby mode, in which relatively less power is consumed, is increased in each time period so that the standby power consumption value is decreased from a previous value.

According to one embodiment of the present invention, when the standby power consumption value is compared with the reference standby power value and the reference standby power consumption value is smaller than or equal to the reference standby power value, the threshold value may be maintained without change (630).

FIG. 7 is a flowchart illustrating a method of resetting a preset threshold value using a prediction success rate according to one embodiment of the present invention.

Referring to FIG. 7, the method of resetting a preset threshold value by which a standby mode is determined using a prediction success rate is shown.

According to one embodiment of the present invention, the prediction success rate may refer to a ratio of the number of transitions from the active standby mode to the active state to the total number of transitions from a standby mode to the active state.

According to one embodiment of the present invention, the prediction success rate is compared with a reference success rate (710).

Here, the reference success rate may be set as a success rate that is considered appropriate by a user.

According to one embodiment of the present invention, when the prediction success rate is compared with the reference success rate and is lower than the reference success rate, the threshold value may be decreased (620).

When the threshold value is decreased, a duration of time spent in the active standby mode is increased while a duration of time spent in the passive standby mode is reduced in each time period so that a rate of transition from the active standby mode to the active state is increased, thereby increasing the prediction success rate.

According to one embodiment of the present invention, when the prediction success rate is compared with the reference success rate and is higher than or equal to the reference success rate, the threshold value may be maintained without change (630).

FIG. 8 is a diagram illustrating a calculation of a usage probability of a user using a terminal by using day, month, season, and weather information for each time period.

According to one embodiment of the present invention, daily activation information of a terminal is collected and accumulated.

The accumulated daily activation information is analyzed to generate activation probability information according to a viewing event using day, month, season, and weather information for each time period.

According to the above embodiment, a viewing probability may be calculated by applying current information to the generated activation probability information, and when the viewing probability is lower than a preset threshold value, a standby mode may be set to the passive standby mode, and when the viewing probability is higher than the preset threshold value, a standby mode may be set to the active standby mode.

FIG. 9 is a diagram illustrating a calculation of a usage probability of a user using a terminal by using characteristic information of a region or a place.

According to one embodiment of the present invention, place information may be extracted from a terminal, and a viewing-event-dependent activation probability may be generated using the extracted place information according to each characteristic of a region or a place.

According to the above embodiment, a viewing probability may be calculated by applying current information to generated activation probability information, and when the viewing probability is lower than a preset threshold value, a standby mode may be set to the passive standby mode, and when the viewing probability is higher than the present threshold value, a standby mode may be set to the active standby mode.

FIG. 10 is a diagram illustrating a calculation of a usage probability of a user using a terminal by using user personal information generated by analyzing a terminal activation history according to one embodiment of the present invention.

According to one embodiment of the present invention, daily information on whether a terminal is used may be accumulated and a viewing-event-dependent activation probability by viewer age may be generated from the accumulated daily information.

According to the above embodiment, a viewer age may be inferred using the generated activation probability information, and either the active standby mode or the passive standby mode is set using the inferred viewer age according to an age of a user.

FIG. 11 is a flowchart illustrating a standby control method for saving power consumption of a terminal.

A terminal activation history during a predetermined period of time is collected (1110).

According to one embodiment of the present invention, the terminal activation history during the predetermined period of time may be collected.

Here, the predetermined period of time refers to a period arbitrarily set by a user, and may be set by the user in units of days, weeks, months, years, etc. without limitation.

Cumulative activation history information is generated using the collected activation history (1120).

According to one embodiment of the present invention, the cumulative activation history information may be generated by accumulating the collected activation history for each time period.

According to one embodiment of the present invention, the cumulative activation history information may be generated by accumulating an activation history for each time period in units of 2 hours, but is not limited thereto. The cumulative activation history may be accumulated for each time period in units of seconds, minutes, hours, days, etc.

A standby mode is determined by comparing the cumulative activation history information with a threshold value (1130).

According to one embodiment of the present invention, the cumulative activation history of each time period contained in the generated cumulative activation history information may be compared with a preset threshold value, and the terminal may be set to the active standby mode in a corresponding time period when a period of activation time is greater than the threshold value, and the terminal may be set to the passive standby mode in a corresponding time period when the period of activation time is smaller than the threshold value.

In this case, the active standby mode may refer to a mode in which most functions of the terminal are activated and stand by in the operation-favored state.

In contrast, the passive standby mode may refer to a mode in which most of the functions of the terminal are deactivated and stand by in the power saving-favored state.

According to one embodiment of the present invention, the threshold value may be determined by the user, and according to another embodiment, the preset threshold value may be updated periodically.

According to one embodiment of the present invention, the preset threshold value may be reset using a standby power consumption value and a prediction success rate in each preset period of time.

According to one embodiment, when the standby power consumption value, which is the total sum of power consumed by the terminal in a standby mode during a specific period of time, is greater than a reference standby power consumption value, the threshold value may be increased.

In this case, the standby power consumption value may refer to the total sum of power consumption occurring due to a corresponding terminal standing by in the active standby mode or in the passive standby mode for a specific period of time.

According to one embodiment of the present invention, the threshold value may be decreased when the prediction success rate, which is a rate of a terminal being activated from the active standby mode when the terminal is switched from a standby mode to the active mode, is lower than a reference success rate.

In this case, the prediction success rate may refer to a ratio of the number of transitions from the active standby mode to the active state to the total number of transitions from a standby mode to the active state.

According to one embodiment of the present invention, a usage probability of the user using the terminal may be calculated, the terminal may be set to the active standby mode when the usage probability is higher than a reference usage probability, and the terminal may be set to the passive standby mode when the usage probability is lower than the reference usage probability.

In this case, the usage probability of the user using the terminal may be calculated using day, month, season, and weather information for each time period, using characteristic information of a region or a place, or using user personal information generated by analyzing a terminal activation history.

For reference, the elements according to an embodiment of the present invention illustrated in FIGS. 1 to 3 may each be implemented in the form of software or in the form of hardware such as a field programmable gate array (FPGA) or an application specific integrated circuit (ASIC) and may perform certain functions.

However, the elements are not limited to software or hardware in meaning. In other embodiments, each of the elements may be configured to be stored in a storage medium capable of being addressed, or may be configured to execute one or more processors.

Therefore, for example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

Elements and a function provided in corresponding elements may be combined into fewer elements or may be further divided into additional elements.

Meanwhile, the standby control apparatus according to the first to third embodiments may include a communication module (not shown), a memory (not shown), and a processor (not shown), and operate the components shown in FIGS. 1 to 3.

The communication module may transceiver data with one or more terminal. In this case, the communication module may include a wired communication module and a wireless communication module. The wired communication module may be implemented with a power line communication device, a telephone line communication device, a cable home (MoCA), Ethernet, IEEE1294, an integration wired home network, an RS-485 control device, and/or the like. Also, the wireless communication module may be implemented with WLAN, Bluetooth, HDR WPAN, UWB, ZigBee, impulse radio, 60 GHz WPAN, binary-CDMA, wireless USB technology, wireless HDMI technology, and/or the like.

The memory may store programs for respectively operating the elements and the processor may execute the programs. Here, the memory may be a generic name for a volatile memory and a nonvolatile memory that continuously maintains stored information even when power is supplied thereto.

For example, examples of the memory may include NAND flash memory such as a compact flash (CF) card, a secure digital (SD) card, a memory stick, a solid state driver (SSD), and a micro SD card, a magnetic computer memory device such as a hard disk drive (HDD), and an optical disk drive such a CD-ROM and a DVD-ROM.

Moreover, the programs stored in the memory may each be implemented in the form of software or in the form of hardware such as an FPGA or an ASIC and may perform certain functions.

According to the present invention, a standby mode is controlled by predicting a terminal usage pattern of a user, and thus it is possible to provide user convenience and to save power consumption during the standby period. In addition, it is possible to more effectively save power consumption during the standby period through more accurate prediction using a usage probability calculated by analyzing context information.

Meanwhile, the method according to an exemplary embodiment of the inventive concept may be implemented by a computer program stored in a medium which is executed by a computer, or in a form of a recording medium including an instruction which is executable by the computer. The computer readable medium may be any available medium which is accessible by the computer, and include volatile and non-volatile media, and removable and non-removable media. Further, the computer readable medium may include a computer storage medium and a communication medium. The computer storage medium may include volatile and non-volatile media and removable and non-removable media implemented by any method and technology of storing information such as a computer-readable instruction, a data structure, a program module, or other data. The communication medium may include other data or other transmission mechanisms of a modulated data signal such as a computer readable instruction, a data structure, a program module or a carrier wave, and include any information transmission medium.

While the method and the system of the inventive concept are described with reference to a specific exemplary embodiment, all or a portion of the components or the operations may be implemented by using a computer system having a general-purpose hardware architecture.

While the exemplary embodiments of the inventive concept are described in detail above, it will be understood by those of ordinary skill in the art that various changes and modifications in form and details may be made therein without departing from the spirit and scope as defined by the following claims. Therefore, it will be understood that the exemplary embodiments described above are merely examples in every aspect, and the inventive concept is not limited thereto. For example, each component described in a single type may be implemented in a distributed type, and similarly, components described in the distributed type may be implemented in a combined type.

The scope of the inventive concept should be defined by claims, and it is intended that the inventive concept covers all such modifications and changes by those of ordinary skill in the art derived from a basic concept of the appended claims, and their equivalents.

What is claimed is:

1. A standby mode control apparatus comprising a communication module, a memory, and a processor, and configured to save power consumption of a terminal which is operated by the processor configured to execute a program stored in the memory, wherein the processor includes:
an activation history information generator configured to collect a terminal activation history during a predetermined period of time and accumulate the collected activation history for each time period to generate cumulative activation history information; and
a standby mode determiner configured to compare a cumulative activation history of each time period contained in the generated cumulative activation history information with a preset threshold value, set a terminal to an active standby mode in a corresponding time period when a period of activation time is greater than the threshold value, and set the terminal to a passive standby mode in a corresponding time period when the period of activation time is smaller than the threshold value.

2. The standby mode control apparatus of claim 1, wherein the processor further includes a threshold value setter configured to reset the preset threshold value using a standby power consumption value and a prediction success rate in each preset period of time.

3. The standby mode control apparatus of claim 2, wherein the threshold value setter increases the threshold value when the standby power consumption value, which is a total sum of power consumed by the terminal in a standby mode during a specific period of time, is greater than a reference standby power consumption value.

4. The standby mode control apparatus of claim 2, wherein the threshold value setter decreases the threshold value when the prediction success rate, which is a rate of the terminal being activated from the active standby mode when the terminal is switched from a standby mode to an active mode, is lower than a reference success rate.

5. The standby mode control apparatus of claim 1, wherein the processor further includes a usage probability applier configured to calculate a usage probability of a user using the terminal, set the terminal to the active standby mode when the usage probability is higher than a reference usage probability, and set the terminal to the passive standby mode when the usage probability is lower than the reference usage probability.

6. The standby mode control apparatus of claim 5, wherein the usage probability applier calculates the usage probability of the user using the terminal using day, month, season, and weather information for each time period.

7. The standby mode control apparatus of claim 5, wherein the usage probability applier calculates the usage probability of the user using the terminal using characteristic information of a region or a place.

8. The standby mode control apparatus of claim 5, wherein the usage probability applier calculates the usage probability of the user using the terminal using user personal information generated by analyzing the terminal activation history.

9. A standby mode control method for saving power consumption of a terminal, comprising:
collecting a terminal activation history during a predetermined period of time and generating cumulative activation history information by accumulating the collected activation history for each time period; and
comparing a cumulative activation history of each time period contained in the generated cumulative activation history information with a preset threshold value, setting a terminal to an active standby mode in a corresponding time period when a period of activation time is greater than the threshold value, and setting the terminal to a passive standby mode in a corresponding time period when the period of activation time is smaller than the threshold value.

10. The standby mode control method of claim 9, further comprising resetting the preset threshold value using a standby power consumption value and a prediction success rate in each preset period of time.

11. The standby mode control method of claim 10, wherein the resetting of the threshold value includes increasing the threshold value when the standby power consumption value, which is a total sum of power consumed by the terminal in a standby mode during a specific period of time, is greater than a reference standby power consumption value.

12. The standby mode control method of claim 10, wherein the resetting of the threshold value includes decreasing the threshold value when the prediction success rate, which is a rate of the terminal being activated from the active standby mode when the terminal is switched from a standby mode to an active mode, is lower than a reference success rate.

13. The standby mode control method of claim 9, further comprising calculating a usage probability of a user using the terminal, setting the terminal to the active standby mode when the usage probability is higher than a reference usage probability, and setting the terminal to the passive standby mode when the usage probability is lower than the reference usage probability.

14. The standby mode control method of claim 13, wherein the setting of the terminal to the passive standby mode includes calculating the usage probability of the user using the terminal using day, month, season, and weather information for each time period.

15. The standby mode control method of claim 13, wherein the setting of the terminal to the passive standby mode includes calculating the usage probability of the user using the terminal using characteristic information of a region or a place.

16. The standby mode control method of claim 13, wherein the setting of the terminal to the passive standby mode includes calculating the usage probability of the user using the terminal using user personal information generated by analyzing the terminal activation history.
